(19) United States
(12) Patent Application Publication
(10) Pub. No.: US 2018/0126342 A1
(43) Pub. Date: May 10, 2018

(54) COLOR MATCHING DEVICE

(71) Applicant: Chelsea Kent, Los Angeles, CA (US)

(72) Inventor: Chelsea Kent, Los Angeles, CA (US)

(21) Appl. No.: 15/804,649

(22) Filed: Nov. 6, 2017

Related U.S. Application Data
(60) Provisional application No. 62/418,486, filed on Nov. 7, 2016.

(51) Int. Cl. B01F 13/00; B01F 13/10; B01F 15/00; B01F 15/02; B01F 3/08; A45D 34/04; G01J 3/46

(52) U.S. Cl. CPC B01F 13/002; B01F 13/1055; B01F 15/00259; B01F 15/00253; B01F 2215/0031; B01F 3/08; A45D 34/042; G01J 3/46; B01F 15/0246

(57) ABSTRACT

A color matching device that can digitally scan an image color, process the image color to create a formula for a color matching the image color, mix the matching color, and dispense the matching color, all in a single, hand-held device.

### CROSS-REFERENCE TO RELATED APPLICATION

This application claims priority to U.S. Provisional Patent Application No. 62/418,486 filed on Nov. 7, 2016, the disclosure of which, including any materials incorporated by reference therein, are incorporated herein by reference in their entireties.

### BACKGROUND OF THE INVENTION

The present invention generally relates to a color matching device, in particular, to a color matching device that can digitally scan an image color, process the image color to create a formula for color matching the image color, mix the matching color, and dispense the matching color, all in a single, hand-held device.

Currently, systems such as paint mixers can be found at hardware stores that allow for batches of paint to be created to match a desired color. These systems, however, are multi-part systems that require bulky pumps, and are not intended to mix smaller batches of paint and/or color. As such, small batches of color cannot be made to accurately match the desired color.

Similarly, existing pen devices fail at accurate color matching because these systems cannot provide continuous, consistent color through the small tip of the pen device. An example of such a writing instrument is described in U.S. Pat. No. 6,749,355 and WO2009091596 A1, each of which is incorporated by reference as if fully recited herein.

Accordingly, there is a need for an improved, color-matching device that can create small, but accurate, batches of matched color for various applications.

### SUMMARY OF THE INVENTION

A color matching device having a main body and a cap removably attached to the main body at a distal end thereof, a sensor for scanning an image color, a flexible printed circuit electrically connected to the sensor to process scanned color, a first ink supply reservoir holding a first color, a second ink supply reservoir holding a second color, a third ink supply reservoir holding a third color. The device also has a first piezo pump connected to the first ink supply reservoir to dispense the first color, a second piezo pump connected to the second ink supply reservoir to dispense the second color, a third piezo pump connected to the third ink supply reservoir to dispense the third color. The device further has a first dispensing tube connected to the first piezo pump to dispense the first color, a second dispensing tube connected to the first piezo pump to dispense the second color, a third dispensing tube connected to said first piezo pump to dispense the third color. Also provided in the device is a mixing reservoir held within the main body of the device and fluidly connected to first, second and third dispensing tubes for mixing one or more of the first, second and third colors to create a mixed color. An applicator for dispensing said mixed color is also provided in the device.

The first, second, and third piezo pumps can also have a micro diaphragm and/or a membrane pump. The color matching device can also have a mixing reservoir that is removable from said main housing by a user for cleaning in between uses. The color matching device can also have a compartment door provided in the main housing provides access to the first, second, and third ink supply reservoirs.

### BRIEF DESCRIPTION OF THE DRAWINGS

A more complete understanding of the present invention may be obtained by reference to the Detailed Description when taken in conjunction with the accompanying Drawings.

FIG. 1 is a perspective view of the color-matching device in accordance with one aspect of the present invention;

FIG. 2 is a cross-sectional view of the color-matching device in accordance with one aspect of the present invention;

FIG. 3 is an exploded view of the color-matching device in accordance with one aspect of the present invention;

FIGS. 4A & 4B are additional views of the color-matching device with access to the ink reservoirs shown; and

FIG. 5A-5F are various plan views of the color matching device, where

FIG. 5A is a front plan view, FIG. 5B is a rear plan view, FIG. 5C is a left plan view, FIG. 5D is a right plan view, FIG. 5E is a top plan view and FIG. 5F is a bottom plan view.

### DETAILED DESCRIPTION OF THE DRAWINGS

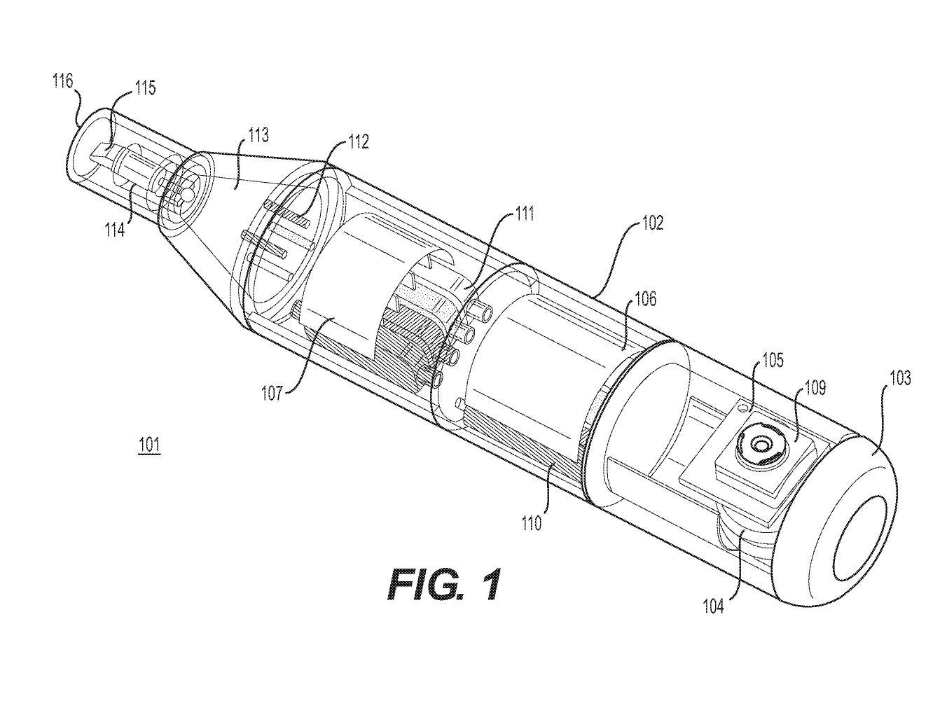

Referring now to the FIGS. 1 & 2, an exemplary color matching device 101 is shown. The color matching device has a main body 102 and a cap or top 103 removably attached to a distal end of main body 102. Components housed within main body 102 include a battery 104, at least one flexible printed circuit (“FPC”) 105, 106, and 107, camera board sensor 109, ink supply reservoirs 110, piezo pump(s) 111, ink dispensing tubes 112, and a mixing reservoir 113.

Cap or top 103 is used to close the opening to the housing of the battery 104. Cap or top 103 can be screwed on or removably attached by other means. Battery 104 is replaceable and could be of the rechargeable type. Battery 104 is used to power the various electrical components held within color matching device 101.

Main body 102 generally houses the mechanical and electrical components of color matching device 101 to create a compact, hand-held device. Main body 102 can come in a variety of sizes but should be small enough to be hand-held. In one embodiment, main body has a 25 mm diameter and a length of 104 mm (1 inch by 4 inches). In a second embodiment, main body has a 20 mm diameter and a length of 104 mm (0.75 inches by 4 inches). In a third embodiment, main body has a diameter of 20 mm and a length of 124 mm (0.75 inches by 4.9 inches).

FPCs 105, 106, 107 electrically connect the various hardware components of the device to perform the various functions of the device using software programmed therein. For example, once an image color is scanned, software determines the volume of each ink color to be dispensed by ink supply reservoir 110 to create a color matching to the image color.

Ink supply reservoirs 110 generally hold the ink supply for the device. Each ink supply reservoirs 110 can hold one of C/M/Y/K or R/B/G to create a matching color. In one exemplary embodiment, 0.2 ml to 0.7 ml of each color can be held, depending on the size of the main body 102.

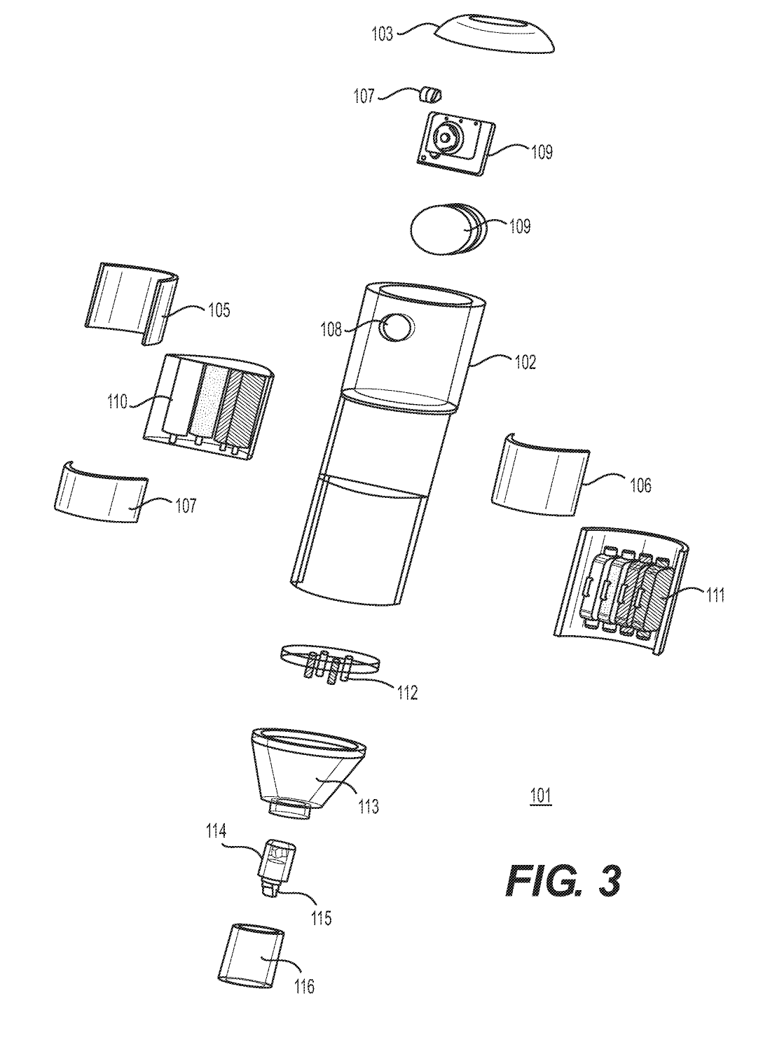

FIG. 3 shows an exploded view of the various components of the device. Reference numerals correspond to those in other FIGS.

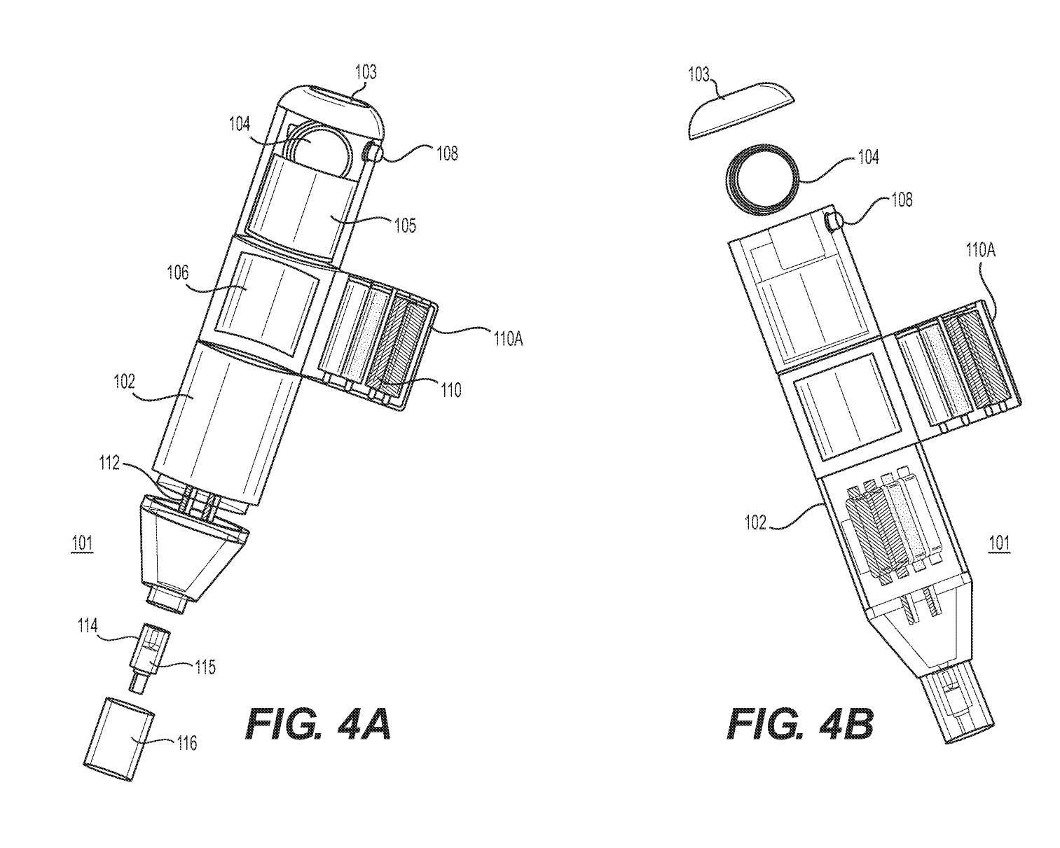

Turning to FIGS. 4A and 4B, ink supply reservoirs 110 can be accessed and replaced by opening compartment door 110A. Ink supply reservoirs 110 could be replaced individually, refilled, or replaced as a set.

Connected to ink supply reservoirs 110 are piezo pumps 111 to move color from ink supply reservoirs to dispensing ink tubes 112. Piezo pumps 111 comprise a micro-diaphragm and/or membrane pump, which allow for precise ink release. Dispensing ink tubes 112 comprise a tubing system that transports ink that is released from the pump down into the mixing reservoir 113. Ink is released in order and colors mixed in mixing reservoir 113. Mixing reservoir 113 can be removable, replaceable and washable so that subsequent color will not be tainted by previously-mixed colors.

At the dispensing or applicator end of the matching device is an applicator housing 114, applicator tip 115, and applicator cap 116. Applicator housing 114 generally provides a casing for applicator tip 115. Applicator tip 115 dispenses the mixed ink to the desired medium. Applicator cap 116 can be placed on applicator tip 115 so that the device can be stored without inadvertent dispensing of color.

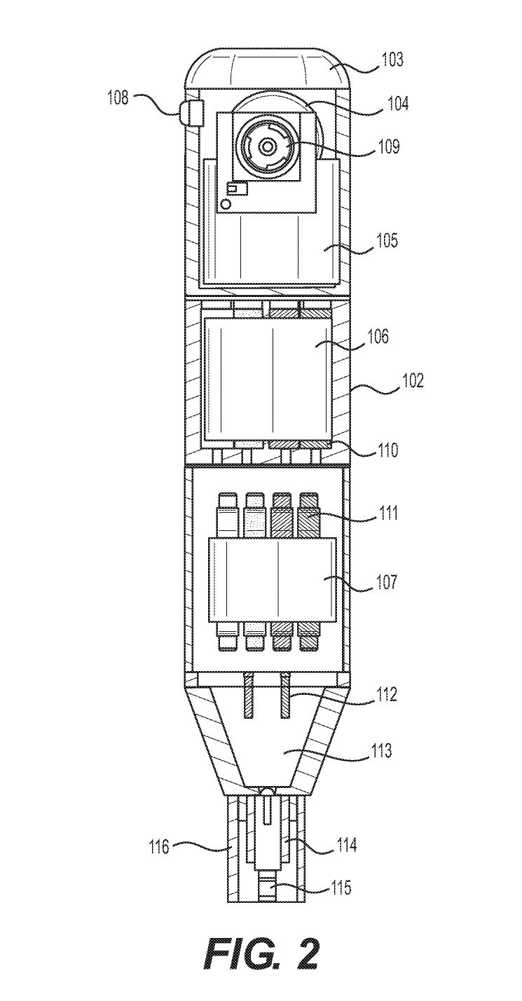

Switch 108 is provided on a side of the main housing 102 to activate the device to start capturing the image color, for example, as can be seen in FIG. 2. As switch 108 actuated, camera board sensor is initiated to collect an image color to color match from.

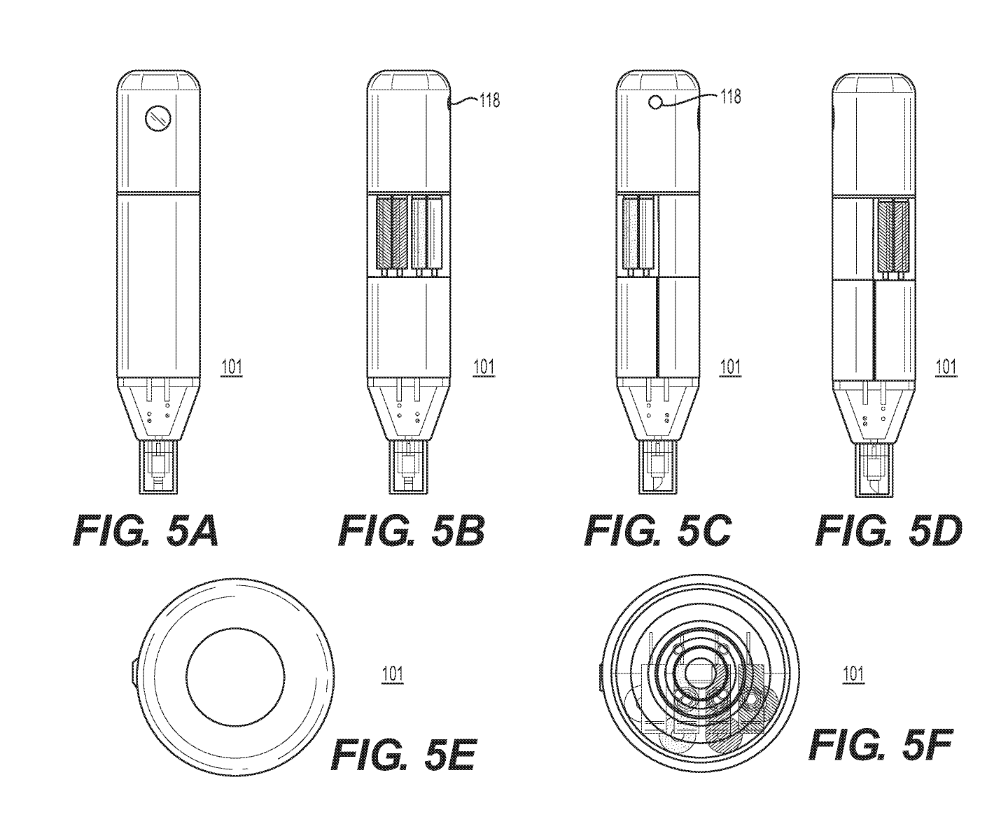

In operation, camera aperture 118 (shown in FIGS. 5B & 5C) of color-matching device is directed toward an object to which the color is to be matched, switch 108 is activated, and the color is captured or scanned by camera board sensor 109. The captured color is then processed by the FPCs 105-107 and piezo pumps 111 dispense the appropriate amounts of color from the ink supply reservoirs 113 to be dispensed into the mixing reservoir 113 through ink dispensing tubes 112. Once the color is mixed in mixing reservoir 113, the color can be dispensed through the applicator tip 115.

For example, if a user wishes to match lipstick to the user's shirt, the user can direct the camera aperture 118 of the color matching device 101 toward the shirt. The user actuates the device by pressing and/or holding the switch. The color matching device reads and scans the color, mixes the appropriate color, and the color can be applied to the user's lips. The device can be used in other cosmetic applications, such as for foundation, cover-up, nail polish, or any kind of cosmetic requiring color. The device can also be used to create touch-up paint for cars. Other applications are envisioned in industries requiring various color matching.

Piezo pumps allow for mechanical energy to be used to eject droplets of fluid in precise volume. The droplet characteristic can be manipulated and controlled using drive waveform or jetting electrical pulse. Piezo pumps allow for delivery of very precise volumes of color as precision of dispensing volume of fluid is critical for color-matching.

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A color matching device comprising:
a main body and a cap removably attached to said main body at a distal end thereof;
a sensor for scanning an image color;
a flexible printed circuit electrically connected to said sensor to process scanned color;
a first ink supply reservoir holding a first color;
a second ink supply reservoir holding a second color;
a third ink supply reservoir holding a third color;
a first piezo pump connected to said first ink supply reservoir to dispense said first color;
a second piezo pump connected to said second ink supply reservoir to dispense said second color;
a third piezo pump connected to said third ink supply reservoir to dispense said third color;
a first dispensing tube connected to said first piezo pump to dispense the first color;
a second dispensing tube connected to said second piezo pump to dispense the second color;
a third dispensing tube connected to said third piezo pump to dispense the third color;
a mixing reservoir held within said main body of the device and fluidly connected to first, second and third dispensing tubes for mixing one or more of said first, second and third colors to create a mixed color; and
an applicator for dispensing said mixed color.

2. The color matching device of claim 1, wherein said first, second, and third piezo pumps comprises a micro diaphragm.

3. The color matching device of claim 1, wherein said first, second, and third piezo pumps comprises a membrane pump.

4. The color matching device of claim 1, wherein said mixing reservoir is removable from said main housing by a user for cleaning in between uses.

5. The color matching device of claim 1, wherein a compartment door provided in said main housing provides access to said first, second, and third ink supply reservoirs.
